(19) United States
(12) Patent Application Publication
(10) Pub. No.: US 2026/0067696 A1
(43) Pub. Date: Mar. 5, 2026

(54) USER DEVICE, A SYSTEM AND A METHOD FOR RECEIVING A NOTIFICATION, SAID RECEPTION BEING DEPENDENT UPON A GEOGRAPHICAL LOCATION OF THE USER DEVICE

(71) Applicant: 360ofme, Inc., Detroit, MI (US)

(72) Inventor: Philippe Miliau Georges Le Berre, Versoix (CH)

(73) Assignee: 360ofme, Inc., Detroit, MI (US)

(21) Appl. No.: 18/825,530

(22) Filed: Sep. 5, 2024

(51) Int. Cl. H04W 12/63; H04W 4/029

(52) U.S. Cl. CPC H04W 12/63; H04W 4/029

(57) ABSTRACT

The present document discloses systems and methods to allow a location-aware user device having a receiver, such as a GNSS-enabled receiver, to notify a third party of its presence at or near a geographical location of interest to the third party on condition that a user of the user device has given their consent to do so. The notification is provided in such a way that the third party knows that the user device's location complies with one or more predetermined rules describing its location with respect to one or more locations of interest without the third party necessarily learning the exact location of the user device.

### TECHNICAL DOMAIN

The concepts described herein relate generally to the field of digital data processing, especially when applied to wireless communication techniques. More particularly, systems and methods described herein may be used to allow for privacy-preserving implementation of third-party location-based services or location-enhanced services on location-aware devices.

### BACKGROUND

Geolocation is a technique used in the domain of electronic communications for identifying the geographical location of connected electronic devices. Some types of connected electronic devices, such as smartphones or connected watches, may be carried by a user or worn by the user, which implies that by geolocating a device, the device's user can be geolocated by association. This is also true for other types of connected devices such as dashboard camera in a car: if the so-called dashcam can be geolocated then the car and the user, i.e. the driver of the car, can also be geolocated.

Different techniques may be used to carry out geolocation of a connected device, such as through the use of the device's Internet Protocol address (IP address) or through triangulation methods, which make use of angles measured between a connected device and known landmarks or through trilateration methods which estimate distances of connected devices from multiple signal sources by measuring the signal strength from each of the sources at the device. Many connected devices have radio receivers which are configured to receive satellite signals which can be converted into geolocation data which can be used to calculate a geographical location of the connected device. Such devices rely on at least one from any of the known Global Navigational Satellite Systems, such as GPS or Galileo, etc. The devices convert signals received from the satellites into Global Navigational Satellite System related data for performing geolocation of the device, either by the device itself or by another processor configured to geolocate the device. Geolocation of such devices may be performed through the use of the Global Navigational Satellite System related data (GNSS-related data) from the device, including geographical coordinates such as latitude and longitude coordinates as they relate to specific times and dates. GNSS-related data may also include direction and so the process of geolocation may include predicting when the connected device will arrive at a given geographical location. Connected devices which are configured to calculate their geographical location using geolocation techniques, or which are configured to provide a remote processor with geolocation data to allow its geographical location to be calculated, are known as location-aware devices.

Geolocation data is any data from a connected device which will allow the device to be geolocated. Geolocation data may be historic in nature in that it may be used to calculate or otherwise track a trajectory made by a corresponding connected device, or more generally to inform of the device's geographical location history when a record of updates over time of the device's geolocation data has been stored. As well as allowing to derive a trajectory of a connected device, geolocation data may also inform about other aspects regarding the behavior of the user of the device: for example, the absence of updated values over certain timeframes may indicate that the user has expressly set the device to a mode where it no longer records geolocation data, for example in a “go-dark” mode, or where the GNSS capability of the receiver has been temporarily switched off.

In the case where GNSS-related data is used for performing geolocation, geolocation data can include geographical coordinates and corresponding times as well as directions. Geographical coordinates may include latitude and longitude coordinates and may further include altitude indices as well as corresponding timestamps. Geolocation enables a connected device's present geographical location to be derived and can allow for past geographical locations of the device to be calculated and/or for the device's future geographical locations to be predicted or otherwise estimated. Geolocation data may also include the geographical location of the connected device with respect to the geographical location of a predetermined location of interest.

Third parties may provide location-based services or location-enhanced services to users of connected devices, where in exchange for sharing the device's geolocation data with the third party, the user may enjoy a service which is tailored to the user in terms of his or her present, past or expected future geographical location. For example, if a user does a search for a restaurant, a location-enhanced search service may ensure that the search results correspond to restaurants which are close to where the user is located. Location-based and location-enhanced services therefore leverage the geolocation data of a user's device to provide tailored experiences to the user, enhance service delivery and drive business value.

On the other hand, indiscriminate collection and use of geolocation data allowing for precise determination of a device's geographical location raises significant privacy concerns. Consequently, various privacy-preserving techniques have been proposed such as geomasking and geofuzzing.

Geomasking involves altering precise geographical coordinates of a device's geolocation data to provide a less accurate version of the device's geographical location or to obfuscate the device's geographic location. Geofuzzing is a process where random or pseudo-random noise is introduced to the geolocation data so as to achieve a similar result. U.S. Pat. No. 9,756,560 B2 discloses a method of adaptive geofuzzing where the actual geographical location of a device can be perturbed by varying amounts depending on whether the device is near to one or more predetermined locations which the user deems as being sensitive or not.

Although these methods of geomasking and geofuzzing can protect the user's privacy by ensuring that their exact geographical location is not disclosed, they still fundamentally provide a geographical location. Since the geographical location provided is a “false” one, the underlying business need for which the geolocation data was requested by the third party offering the location-based service or the location-enhanced service. For example, a service provider may want to know the geographical location of a user device to be able to determine whether the user is within a given distance from a particular point of interest such as a store owned or managed by the service provider or to be able to determine whether the user has entered a particular geographical area. The goal of the third party is to use this information to trigger the sending of a notification to the user that will enhance the user's experience and fulfill certain business objectives. However, by reducing the accuracy and reliability of their geolocation data using geomasking or geofuzzing techniques, this creates a conflict meaning that the business objectives may not be achieved. There exists, therefore, a conflict between the desire to protect user privacy and the business need to be able to process the geolocation data effectively and accurately.

U.S. Patent Application Publication Number 2010/0077484 A1 discloses a location tracking privacy engine that is configured to allow users to define privacy policies that govern the manner in which, if at all, location information about each user is provided to third parties offering location-based or location-enhanced services. The location tracking privacy engine is placed between the user's location tracking system and the third-party system offering the services. Privacy policies can be defined in a highly flexible and context-specific manner such that the execution of a given privacy policy by the location tracking privacy engine is dependent on the existence of one or more social, topical, temporal or spatial conditions. Privacy policies are then executed automatically by the location tracking privacy engine when the conditions associated with the policies are determined to be satisfied. The different manners in which location information may be provided include withholding the information from the third party, modifying the location information (geomasking) and altering a granularity of the location information (geofuzzing).

The known privacy-preserving techniques, while valuable, do not fully reconcile the conflict between the user's desire for privacy and the third party's ability to provide a tailored experience to the user while meeting their own business objectives. The result is a compromise which leads to a suboptimal service received by the user and diminished business value perceived by the third party. There remains therefore a precious need for an innovative solution that addresses these challenges.

### BRIEF SUMMARY

Given the need for a user to be able to share their geographic location or other geolocation data with third parties in a privacy-preserving manner, the present disclosure describes an approach involving data minimization, whereby certain geolocation-related data is shared by a user, where such geolocation-related data is sufficient to allow the third party to know whether the user's connected electronic device fulfils certain geographical-related conditions but is insufficient to allow the third party to derive the geographical location of the user's connected electronic device.

According to a first aspect, there is disclosed herein a system comprising a user device having a wireless receiver, the user device being configured to convert received signals into geolocation data for allowing a geographical location of the user device to be determined and/or updated over time. The system may be configured to allow the user device to receive a notification from a third party, said reception being dependent on said geographical location. According to an embodiment, the user device has access to geofence information pre-established by the third party and stores a set of geopresence rules, a compliance of one or more of said geopresence rules being dependent upon said geographical location relative to said geofence information or said geolocation data relative to said geofence information. The system further comprises a geopresence privacy broker device comprising one or more processors configured to receive said geolocation data or said geographical location from the user device and to generate a geopresence notification based on said geolocation data or said geographical location and/or said geofence information when the geographical location of the user device complies with one or more of said geopresence rules. The system is configured to send the geopresence notification from the geopresence privacy broker device to the third party on condition that the user provides their consent to do so, said geopresence notification comprising sufficient information to allow the third party to know that the user device complies with one or more of the geopresence rules but not allowing for said geographical location to be calculated or updated.

According to one embodiment the receiver is a radio receiver for receiving radio signals, the user device being configured to convert the received radio signals into geolocation data for allowing a geographical location of the user device to be determined and/or updated over time. According to another embodiment, the receiver is an electromagnetic signal receiver for receiving infrared light signals, the user device being configured to convert the received infrared light signals into geolocation data for allowing a geographical location of the user device to be determined and/or updated over time.

According to an embodiment, the user device of the system is configured to operate within a Global Navigation Satellite System (GNSS) and has a GNSS receiver for receiving satellite signals from one or more orbiting satellites from a plurality of orbiting satellites.

According to another embodiment, the user device is configured to operate within a positioning system based on wireless local area network radio signal reception, the user device having a wireless local area network receiver for receiving wireless signals from one or more local area network access points from a plurality of local area network access points. Any of the known wireless local area network technologies may be used, such as Wi-Fi, Li-Fi, Zigbee, LoRaWAN, etc.

According to an embodiment, the user may select a geopresence privacy level to be low, whereupon the geopresence privacy broker will notify the third party of the user device's presence with relative accuracy with respect to one or more places of interest specified by the third party. Should the user select a geopresence privacy level to be high, the geopresence privacy broker may introduce geofuzzing in order to more or less mask the user device's exact position.

According to an embodiment, the geopresence privacy broker can be made to treat places of special significance to the user differently. For example, should the user want to keep their place of residence hidden, they could set the privacy broker to more strongly mask that place. According to an embodiment, the privacy broker may be configured to consider the population density of the area where the user device is located and to modify the notification to the third party to mask the user device's location strongly when the population density is low, for example.

According to an aspect, provision is made for a user device having a wireless receiver, the user device being configured to convert received signals into geolocation data for allowing a geographical location of the user device to be determined and/or updated over time, the user device configured to receive a notification from a third party, said reception being dependent upon said geographical location; wherein the user device has access to geofence information pre-established by the third party and stores a set of geopresence rules, a compliance of one or more of said geopresence rules being dependent upon said geographical location relative to said geofence information or said geolocation data relative to said geofence information; the user device being configured to send said geolocation data or said geographical location to a geopresence privacy broker device when the geographical location of the user device complies with one or more of said geopresence rules.

According to an embodiment, the receiver of the user device is a radio receiver, the receiver being configured to convert received radio signals into geolocation data. According to another embodiment, the receiver is a receiver of electromagnetic radiation, configured to receive infrared light and to convert it into geolocation data.

According to an embodiment, the receiver in the user device is a wireless local area network radio receiver configured to receive said signals from one or more wireless local area network access points from a plurality of wireless local area network access points. According to another embodiment, the receiver in the user device is a satellite receiver configured to receive said signals from one or more orbiting satellites from a constellation of orbiting satellites.

According to yet another aspect, a geopresence privacy broker device is provided, the geopresence privacy broker device comprising one or more processors configured to receive geolocation data or a geographical location from a user device and to generate a geopresence notification based on said geolocation data or said geographical location when the geographical location of the user device complies with one or more predetermined geopresence rules; the geopresence privacy broker device being configured to send the geopresence notification to a third party on condition that a user of the user device provides their consent to do so, said geopresence notification comprising sufficient information to allow the third party to know that the user device complies with one or more of the geopresence rules but not allowing for said geographical location to be calculated or updated.

A method for receiving a notification from a third party by a user device is provided, according to still another aspect, said reception being based on a geographical location of the user device, the user device having a wireless receiver, the user device being configured to convert received signals into geolocation data for allowing the geographical location of the user device to be determined and/or updated over time. The user device has access to geofence information, pre-established by the third party, and it stores a set of geopresence rules, a compliance of one or more of said geopresence rules being dependent upon said geographical location relative to said geofence information or said geolocation data relative to said geofence information. According to this aspect, the method comprises:
sending said geolocation data or said geographical location from the user device to a geopresence privacy broker device comprising one or more processors;
generating, by the one or more processors of the geopresence privacy broker device, a geopresence notification based on said geolocation data or said geographical location and/or said geofence information when the geographical location of the user device complies with one or more of said geopresence rules; and
sending the geopresence notification to the third party on condition that the user provides their consent to do so, said geopresence notification comprising sufficient information to allow the third party to know that the user device complies with one or more of the geopresence rules but not allowing for said geographical location to be calculated or updated.

According to yet still another aspect, provision is made for a non-transitory computer-readable medium storing executable code that, when executed by one or more processing devices, causes the one or more processing devices to perform the method described above.

The present disclosure describes ways of preserving a user's privacy related to his or her use of third party location-based services or location-enhanced services using techniques to minimize the amount of data and the type of data shared with the third party, while ensuring that the third party gets an amount of data of the required type which will allow the third party to provide a useful service to the user while ensuring that the third party receives useful information from the user without breaching the user's privacy according to a set of privacy rules which the user has set up.

Embodiments described herein provide for a user who would not like to disclose their exact geographical location but would still be interested in receiving notifications from service providers when the user crosses a geofence which has been pre-established by the service provider, for example, to be able to decide on how much information to disclose about their location. The amount of information will be enough for the service provider to know that the user qualifies for receiving the location-based notification without the service provider knowing exactly where the user is. By using a geopresence privacy broker service according to embodiments described herein, the user can provide answers to the types of questions a service provider would usually rely on to know when a user has crossed a geofence, without the service provider learning exactly where the user is. For example, the privacy broker, which does know the user's geographical location, can let the service provider know that based on the user's present location, direction and speed, they will cross the service provider's geofence in x minutes, or that the user is close to a predetermined location that the service provider announces as being a location “of interest”, etc.

### BRIEF DESCRIPTION OF THE DRAWINGS

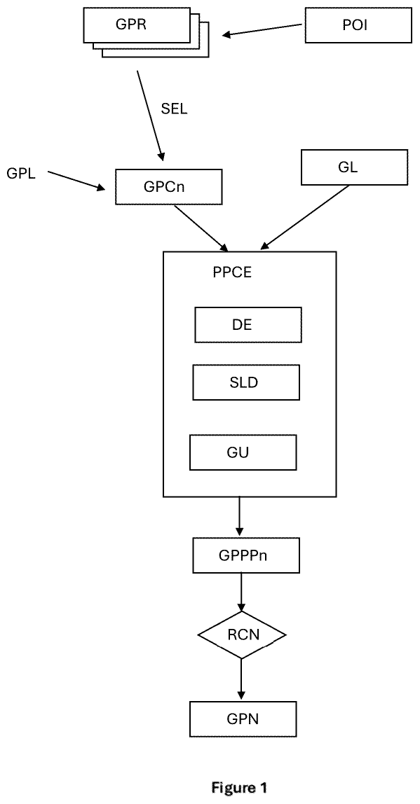

The concepts described herein will be better understood thanks to the detailed description which follows, along with the accompanying drawing, FIG. 1, which shows a process which may be executed in a system according to an embodiment described herein, where a user device notifies a third party of its presence at or near a place of interest to the third party via the intermediary of a geopresence privacy broker device which receives geolocation data or the geographical location of the user device from the user and, on condition that the user has given their consent, informs the third party of the user's presence in terms of a set of predefined rules and with respect to one or more predefined places or regions of interest in a way which prevents the third party from being able to determine the exact location of the user device.

### DETAILED DESCRIPTION

A goal of the present disclosure is to describe how the privacy of a user of a device comprising a Global Navigation Satellite System receiver can be preserved when the device is used to run location-based services or location-enhanced services provided by a third party. The goal is achieved through minimization of the amount and type of information shared with the third party by the user to allow a number of questions related to the geographic location of the user device with respect to one or more predetermined geographic locations to be answered by the third party without the third party actually knowing the geographic location of the user device. By achieving this goal, the privacy concerns of the user are addressed and certain regulatory requirements related to data privacy are met, while ensuring that the third party is able to provide the user with location-based or location-enhanced services to an expected level or to an expected accuracy or relevance, while also allowing the third party to meet their business objectives.

As mentioned above, a service provider may provide a location-based service or a location-enhanced service to a user of a connected device, where in exchange for sharing the device's geolocation data with the third party, the user may enjoy a service which is tailored to the user in terms of his or her present, past or expected future geographical location. The service provider can use the device's geolocation data to perform a geolocation process to determine the present, historic or future geographic location of the device, then use this knowledge to tailor the service for the user according to the geographical location of the user device. However, the service provider may not need to know the precise location of the user to be able to provide the tailored service: it might be sufficient for the service provider simply to know whether the user has left home or whether the user is close to some predetermined geographical location of interest or to have an idea of an estimated time for the user to arrive at a particular location of interest, without necessarily having to know the direction from which the user will arrive at the particular location of interest, for example. More generally, any third party might like to send a notification to a user device, based on a geographical location of the user device. For example, if a driver enters a zone in which a reduced speed limit is in force, a road traffic authority may want to send a notification to that driver to make them aware of the new speed limit. Or, if a company who owns several stores across the country knows that a driver is within a certain distance from one of their stores, the company owner may want to send information to the driver that they are near one of their stores and that they can get there by following a certain path, where they will benefit from certain special offers. The sending of the notification can be considered to be a location-enhanced or location-based service in itself.

In fact, third parties who provide location-based services or location-enhanced services usually only need to know a user's geographical location in order simply to be able to answer certain questions, such as how far the user is away from one or more particular locations or how long it would take the user to get to a particular location or whether the user is within a certain perimeter or geofence or whether the user is moving or stationary, for example. A pertinent question could even be whether the GNSS feature of the user device is switched on or off, i.e. has the user “gone dark”? By knowing the answers to these types of questions, the service provider may be able to offer the user a service which is sufficiently tailored to satisfy the user's wishes when using such a service without having to know the user's precise geographical location. The user may decide on which level of detail should be used in answering the questions depending on which service he or she will be able to enjoy and/or which third party is proposing the service. As such, the user can decide on whether he or she would like a high level of privacy or a low level of privacy depending on which service he or she is about to enjoy.

For the purpose of the present disclosure, geopresence information shall mean information which would provide answers to questions that a location-based or location-enhanced service provider may have about the geographical location of a user in order to be able provide an enhanced user experience while fulfilling certain business objectives, without actually having to know the exact geographic location of the user or a particular behavior of the user. By behavior of the user, it may mean where the user is physically located at the present moment, where they were located at some time in the past, what was their trajectory over a given timeframe, where they are expected to be at some time in the future should they continue along the current trajectory, how close the user is (or was) to a certain location of interest, whether the user is (or was or will be) within a certain geographical perimeter at a given time, what operation mode the user device's GNSS was in at a given time, etc.

FIG. 1 illustrates a process which may be carried out by a system, according to an embodiment, the system comprising a GNNS-enabled user device, and a geopresence privacy broker. The geopresence privacy broker stands between the user and a third party, who is known to the user, or at least one or more places of interest to the third party is known to or accessible by the user device. The user device also has access to a set of geopresence rules which define different scenarios in which the user may be prepared to let the third party know, with more or less accuracy, about his or her proximity to any of the places of interest to the third party. The box POI represents a list of one or more places of interest to the third party and may be used in combination with the geopresence rules, represented by boxes GPR. Examples of geopresence rules, with respect to the places of interest, include: the third party would like to know when the user device enters into any one from (possibly) a plurality of geographical zones, each defined by an m×n parallelogram centered at coordinates (latitude, longitude); or if the user was in that zone up to x minutes ago; or if the user is likely to arrive within the zone in the next t minutes. Another example may be that the third party would like to know whether the user device is currently stationary or moving; or whether the user device was stationary over the past x minutes; or whether the user device's geolocation functions are enabled or disabled, and if so for how long? Yet another example is if the third party wants to know if the user device will from a certain direction within a radius r of a certain place around time t o'clock. The geopresence may involve a place of significance to the user, like the user's home for example. The third party may want to know when the user leaves their home, for example. The user may select one or more of these geopresence rules and configure the user device to respond to a certain third party with more or less accuracy, i.e. the user can choose to comply with a third party's request for geopresence information with respect to a certain geopresence rule. By doing this, the user gives their consent for providing geopresence information to a third party with respect to a given geopresence rule (SEL). The consent is represented by box GPC. By setting a privacy level, the user can choose how accurate the geopresence information will be. The geopresence information is given within a geopresence notification which is sent from the geopresence privacy broker to the third party when the user device satisfies the criteria specified in the geopresence rule. To be able to do this, the geopresence privacy broker receives the actual geolocation data from the user device, or the geographical location (GL), and the user's consent with respect to one or more of the geopresence rules and, optionally, an indication of the level of privacy (GPL) required by the user. With this information, the geolocation notification (GPN) can be built and sent to the third party, so that the third party knows when to send a notification to the user device.

According to an embodiment, the geopresence privacy broker may include a privacy parameter computation engine, shown as PPCE. This computation engine may comprise a density estimator DE and/or a geofuzzing unit GU and it may take account of locations of significance to the user by detecting such locations in a significant location detection unit SLD. The privacy parameter computation engine may be configured to provide one or more geopresence privacy parameters GPPPn applicable for a certain geopresence consent GPCn. The geopresence notification GPN can then be generated for sending to the third party. Depending on whether the location of the user device is at one of the significant locations, the computation engine may ensure that the geopresence notification will more or less precise. Similarly, depending on the population density at the location of the user device or at a significant location or at a location of interest to the third party, the privacy parameter computation engine may alter the accuracy of the information in the geopresence notification. A geofuzzing algorithm used in the geofuzzing unit may be employed to alter the accuracy of the information depending on the density estimator and/or the significant location detection.

As mentioned above, service providers can offer users certain location-based or location-enhanced services if they know something about a user's geographical location. Depending on the service, the service provider may not have to know the exact geographical location, but may be able to provide the service in a way which is pertinent or useful to the user by knowing where the user is with respect to a particular point of interest, or whether the user is within a certain geographical boundary or how long it will take for the user to get to a particular point of interest, for example. Knowing the answers to these types of questions may also be sufficient to satisfy the business needs of the service provider. Thus, the user may enjoy a location-based or location-enhanced service without having to disclose their exact whereabouts to the service provider and may indeed choose which level of precision they are willing to give the service-provider about their location by answering location-related questions the service provider may have to a lesser or greater level of detail. The following is a list of examples of the kind of answers, or geopresence information, a user may be prepared to give to location-related questions, or geopresence rules, that a location-based or location-enhanced service provider may have:
I am now at particular location or I was at the particular location x minutes ago;
I am presently within a given parallelogram centred around a given location or I was within that parallelogram (or definable shape, such as a donut or circle) at a given time;
In x minutes I will arrive at a given location, given my present location, direction and speed;
I am x km away from a given point of interest?
I am approaching a particular point of interest from a given direction/or heading away from a given point of interest in a given direction;
I am going to my 11 am meeting as noted in Calendar ID xxx and shall arrive there 5 minutes before the start;
I am x km away from my home, heading North;
The location-awareness of my device is presently disabled;
I am within the borders of x State;
I am stationary?

1. A system comprising a user device having a wireless receiver, the user device being configured to convert received signals into geolocation data for allowing a geographical location of the user device to be determined and/or updated over time;
the system being configured to allow the user device to receive a notification from a third party, said reception being dependent upon said geographical location;
wherein the user device has access to geofence information pre-established by the third party and stores a set of geopresence rules, a compliance of one or more of said geopresence rules being dependent upon said geographical location relative to said geofence information or said geolocation data relative to said geofence information; and
the system further comprises a geopresence privacy broker device comprising one or more processors configured to receive said geolocation data or said geographical location from the user device and to generate a geopresence notification based on said geolocation data or said geographical location and/or said geofence information when the geographical location of the user device complies with one or more of said geopresence rules;
the system being configured to send the geopresence notification from the geopresence privacy broker device to the third party on condition that the user provides their consent to do so, said geopresence notification comprising sufficient information to allow the third party to know that the user device complies with one or more of the geopresence rules but not allowing for said geographical location to be calculated or updated.

2. The system according to claim 1, wherein said receiver is a radio receiver, the user device being configured to convert received radio signals into geolocation data for allowing a geographical location of the user device to be determined and/or updated over time.

3. The system according to claim 1, wherein said geolocation data includes a geographical location of the user device in terms of longitude and latitude coordinates of the user device and/or an altitude of the user device and/or one or more corresponding timestamps.

4. The system according to claim 1, wherein said geopresence rules include rules to cause the user device to prompt the user for their consent whenever, compared to the geofence information, the user device is at or near, was at or near or will be at or near a place of interest as specified in the geofence information.

5. The system according to claim 1, wherein said geofence information comprises one or more predetermined geographical locations of interest or a list of places of interest whose geographical locations can be derived by the user device or one or more geographical boundaries and/or one or more times of interest and/or a status of the user device such as whether it is mobile or stationary or whether the geolocation data or the geographical location is available.

6. The system according to claim 1, wherein said consent includes a geopresence privacy level indicator, said geopresence privacy broker device having a privacy parameter computation engine configured to take account of the geopresence privacy level indicator when calculating said compliance of the geographical location of the user device with the geopresence rule.

7. The system according to claim 1, wherein said geopresence privacy broker device comprises a privacy parameter computation engine configured to take account of one or more of: a density estimator depending on a population density around the geographical location of the user device; a significant locations detection to take account of further geopresence rules related to one or more predetermined locations; and a geofuzzing algorithm to modify said geolocation-related information.

8. The system according to claim 7, wherein said privacy parameter computation engine is configured to estimate a population density within a boundary specified in the in the geopresence rules or in the geofence information and alter one or more dimensions of said boundary as a function of said estimated population density.

9. The system according to claim 7, wherein said privacy parameter computation engine is configured to introduce geofuzzing into said geopresence notification.

10. The system according to claim 7, wherein said privacy parameter computation engine is configured to introduce geofuzzing into said geopresence notification when said geographical location corresponds to at least one location of significance predetermined by the user.

11. A user device having a wireless receiver, the user device being configured to convert received signals into geolocation data for allowing a geographical location of the user device to be determined and/or updated over time, the user device configured to receive a notification from a third party, said reception being dependent upon said geographical location;
wherein the user device has access to geofence information pre-established by the third party and stores a set of geopresence rules, a compliance of one or more of said geopresence rules being dependent upon said geographical location relative to said geofence information or said geolocation data relative to said geofence information;
the user device being configured to send said geolocation data or said geographical location to a geopresence privacy broker device when the geographical location of the user device complies with one or more of said geopresence rules.

12. The user device according to claim 11, wherein said receiver is a wireless local area network receiver configured to receive infrared light signals from one or more wireless local area network access points selected from a plurality of wireless local area network access points.

13. The user device according to claim 11, wherein said receiver is a wireless local area network receiver configured to receive radio signals from one or more wireless local area network access points selected from a plurality of wireless local area network access points.

14. The user device according to claim 11, wherein said receiver is a satellite receiver configured to receive radio signals from one or more orbiting satellites selected from a constellation of orbiting satellites.

15. A geopresence privacy broker device comprising one or more processors configured to receive geolocation data or a geographical location from a user device and to generate a geopresence notification based on said geolocation data or said geographical location when the geographical location of the user device complies with one or more predetermined geopresence rules;
the geopresence privacy broker device being configured to send the geopresence notification to a third party on condition that a user of the user device provides their consent to do so, said geopresence notification comprising sufficient information to allow the third party to know that the user device complies with one or more of the geopresence rules but not allowing for said geographical location to be calculated or updated.

16. A method for receiving a notification from a third party by a user device, said reception being based on a geographical location of the user device, the user device having a receiver, the user device being configured to convert received signals into geolocation data for allowing the geographical location of the user device to be determined and/or updated over time, the user device having access to geofence information pre-established by the third party and storing a set of geopresence rules, a compliance of one or more of said geopresence rules being dependent upon said geographical location relative to said geofence information or said geolocation data relative to said geofence information, the method comprising:
sending said geolocation data or said geographical location from the user device to a geopresence privacy broker device comprising one or more processors;
generating, by the one or more processors of the geopresence privacy broker device, a geopresence notification based on said geolocation data or said geographical location and/or said geofence information when the geographical location of the user device complies with one or more of said geopresence rules; and
sending the geopresence notification to the third party on condition that the user provides their consent to do so, said geopresence notification comprising sufficient information to allow the third party to know that the user device complies with one or more of the geopresence rules but not allowing for said geographical location to be calculated or updated.

17. A non-transitory computer-readable medium storing executable code that, when executed by one or more processing devices, causes the one or more processing devices to perform the method according to claim 16.
